(19) United States
(12) Patent Application Publication
(10) Pub. No.: US 2025/0306493 A1
(43) Pub. Date: Oct. 2, 2025

(54) CARRIER, TWO-COMPONENT DEVELOPING AGENT, PROCESS CARTRIDGE, IMAGE FORMING APPARATUS, AND IMAGE FORMING METHOD

(71) Applicants: Hiroyuki KISHIDA, Kanagawa (JP); Tohru SUGANUMA, Kanagawa (JP); Masashi NAGAYAMA, Kanagawa (JP); Kento TAKEUCHI, Kanagawa (JP)

(72) Inventors: Hiroyuki KISHIDA, Kanagawa (JP); Tohru SUGANUMA, Kanagawa (JP); Masashi NAGAYAMA, Kanagawa (JP); Kento TAKEUCHI, Kanagawa (JP)

(21) Appl. No.: 19/084,166

(22) Filed: Mar. 19, 2025

(30) Foreign Application Priority Data
Mar. 27, 2024 (JP) 2024-051274

(51) Int. Cl. G03G 9/107; G03G 9/113; G03G 15/09

(52) U.S. Cl. CPC G03G 9/1075; G03G 9/1131; G03G 9/1139; G03G 15/09; G03G 2215/0609

(57) ABSTRACT

A carrier contains a particle containing a core particle and a coating film that covers the core particle, wherein the carrier has a 50 percent particle diameter (D50) is between 40 μm and 60 μm, the content of the carrier having a particle diameter of less than 22 μm is less than 0.10 percent by number, and the content of the carrier having a particle diameter of less than 24 μm is between 0.10 percent by number and 5.00 percent by number.

### CROSS-REFERENCE TO RELATED APPLICATION

This patent application is based on and claims priority pursuant to 35 U.S.C. § 119 to Japanese Patent Application No. 2024-051274, filed on Mar. 27, 2025, in the Japan Patent Office, the entire disclosure of which is hereby incorporated by reference herein.

### BACKGROUND

### Technical Field

The present disclosure is related to a carrier, a two-component developing agent, a process cartridge, an image forming apparatus, and an image forming method.

### Description of the Related Art

In recent years, image forming methods employing electrophotography have been required to achieve high image quality comparable to that of printing. To meet this demand, various improvements and developments have been carried out. Among these challenges, long-term stability of high image quality should be tackled, particularly the occurrence of so-called ghost images, where differences in color density appear when printing an image. To address this problem, improvements have been made to toner, carrier, and developing methods. High image quality stability can be achieved by reducing the resistance of the carrier. However, as a side effect, carrier adhesion to solid printed areas tends to occur more easily, and countermeasures are being implemented in both the carrier and the developing system.

### SUMMARY

According to embodiments of the present disclosure, a carrier is provided which contains a particle containing a core particle and a coating film that covers the core particle, wherein the carrier has a 50 percent particle diameter (D50) is between 40 μm and 60 μm, the content of the carrier having a particle diameter of less than 22 μm is less than 0.10 percent by number, and the content of the carrier having a particle diameter of less than 24 μm is between 0.10 percent by number and 5.00 percent by number.

As another aspect of embodiments of the present disclosure, a two-component developing agent is provided which contains the carrier mentioned above and a toner.

As another aspect of embodiments of the present disclosure, a process cartridge is provided which contains a latent electrostatic image bearer, a charger to charge the surface of the latent electrostatic image bearer to form a latent electrostatic image, a developing device to develop the latent electrostatic image formed on the surface of the latent electrostatic image bearer with the two-component developing agent mentioned above to form a toner image, and a cleaning device to clean the latent electrostatic image bearer.

As another aspect of embodiments of the present disclosure, an image forming apparatus is provided which contains a latent electrostatic image bearer, a charger to charge the surface of the latent electrostatic image bearer to form a latent electrostatic image, an irradiator to irradiate the latent electrostatic image bearer with light to form a latent electrostatic image, a developing device to develop the latent electrostatic image formed on the surface of the latent electrostatic image bearer with the two-component developing agent of claim 4 to form a toner image, a transfer device to transfer the toner image formed on the latent electrostatic image bearer onto a recording medium, and a fixing device to fix the toner image transferred to the recording medium.

As another aspect of embodiments of the present disclosure, an image forming method is provided which includes forming a latent electrostatic image on a latent electrostatic image bearer, developing the latent electrostatic image formed on the latent electrostatic image bearer with the two-component developing agent mentioned above 4 to form a toner image, transferring the toner image formed on the latent electrostatic image bearer to a recording medium, and fixing the toner image transferred to the recording medium.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a vertical stripe chart to explain the ghost image;

FIG. 2 is an example of a printed image of the vertical stripe chart illustrated in FIG. 1, which appears as a defected image;

FIG. 3 is a diagram illustrating an example of a method of measuring volume resistivity of the carrier according to an embodiment of the present disclosure;

FIG. 4 is a diagram illustrating a schematic diagram illustrating an example of the process cartridge according to an embodiment of the present disclosure; and

FIG. 5 is a diagram illustrating the image forming apparatus according to an embodiment of the present disclosure.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure, a carrier for forming an electrophotographic image is provided which reduces carrier adhesion and occurrence of ghost images over a long period of time.

In typical technologies, various improvements have been proposed for carriers for forming latent electrostatic image developing agents, including carriers for electrophotographic image formation. However, the reduction of carrier adhesion and ghost images over long periods has not yet been fully satisfactory, and further improvements are desired.

As a result of extensive research, the present inventors of the present invention have found that using a carrier for forming electrophotographic images containing core particles and a coating film covering the core particles, wherein the 50 percent particle diameter (D50) is 40 to 60 μm, the content of particles with a diameter of less than 22 μm is less than 0.10 percent by number, and the content of particles with a diameter of less than 24 μm is 0.10 to 5.00 percent by number, leads to reduction of long-term carrier adhesion and variations in the image quality such as image density. Its mechanism is deduced in such a way that, by setting the 50 percent particle diameter (D50) of the carrier to a relatively large size of 40 to 60 μm, the carrier is more strongly retained on the developing agent image bearer, thereby reducing the scattering of the carrier onto the latent electrostatic image bearer. As a result, carrier adhesion to the latent electrostatic image bearer is minimized. Furthermore, by including a certain proportion of particles with a diameter of less than 24 μm, the carrier density between the developing agent bearer and latent electrostatic image bearer increases, lowering the electric resistance between the bearers and thereby reducing ghost images. Additionally, if the 50 percent particle diameter (D50) of the carrier is relatively large (40 to 60 μm), contact between carriers within the image forming apparatus causes wear of the coating film, leading to a decrease in electric resistance, resulting in an increased tendency for carrier adhesion in solid images (hereinafter, referred to as solid carrier adhesion). However, carrier particles with a diameter of less than 24 μm, smaller carrier particles, are present between the larger ones, minimizing direct contact between large carrier particles. This minimization, in turn, reduces coating film wear and consequently improves solid carrier adhesion over time.

The present disclosure is described in detail below.

### Carrier for Forming Electrophotographic Images

The carrier for forming electrophotographic images of the present disclosure includes a particle including a core particle and a coating film that covers the core particle, wherein the carrier has a 50 percent particle diameter (D50) is between 40 μm and 60 μm, the content of the carrier having a particle diameter of less than 22 μm is less than 0.10 percent by number, and the content of the carrier having a particle diameter of less than 24 μm is between 0.10 percent by number and 5.00 percent by number. The 50 percent particle diameter (D50) refers to the median diameter, which is the particle size at which a powder is divided into two portions such that the ratio of particles on the larger side and the smaller side is equal.

With the carrier of the present disclosure, carrier adhesion and ghost images can be reduced over a long period.

The term “ghost image” refers to an image that appears on a printed material (printed matter) but was not intended to be formed in the original print. It is an image in which variations in color density occur in areas where the supply and demand of ink or toner contrast.

Ghost images are more likely to occur in printed images where adjacent patterns are arranged parallel to the paper feed direction.

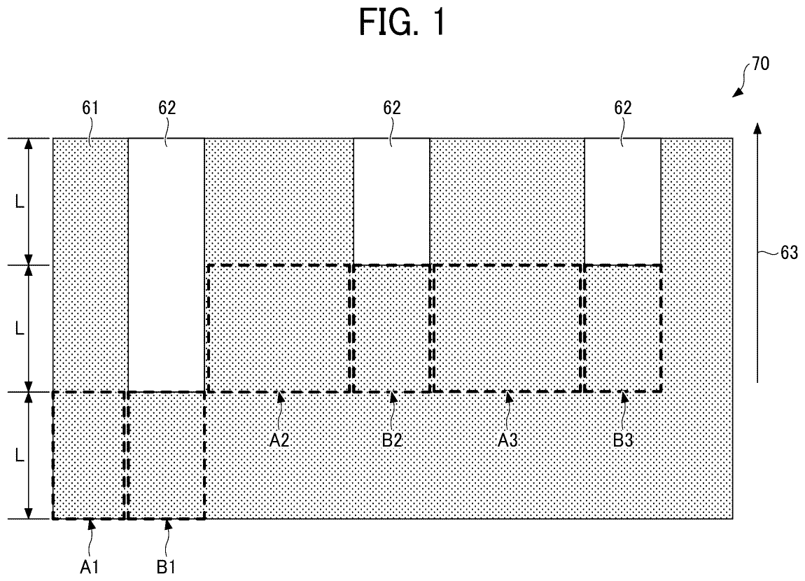

For example, in the case of forming an image of a vertical stripe chart 70 illustrated in FIG. 1, the image is likely to be printed on a recording medium as a ghost image.

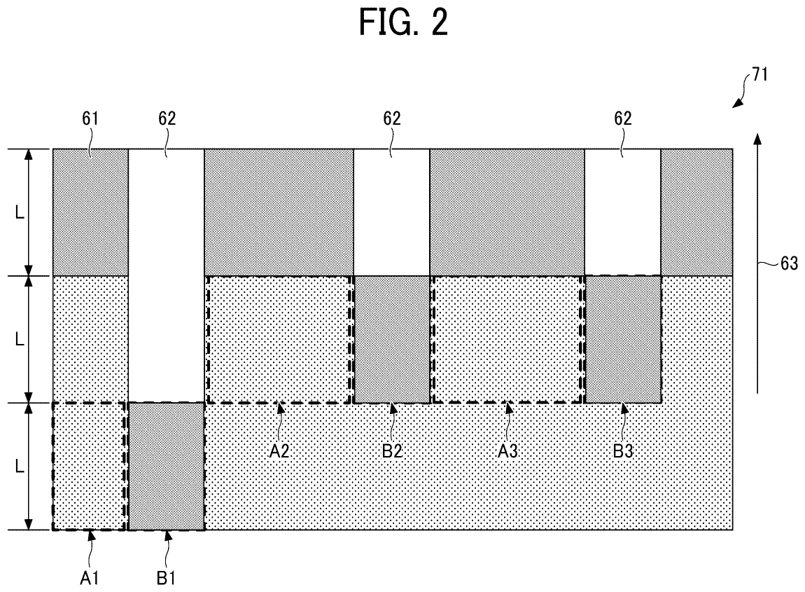

FIG. 2 is an example of a printed image of the vertical stripe chart 70 illustrated in FIG. 1, which appears as a defected image.

In the vertical stripe chart 70 of FIG. 1, there is little difference in color density between the color of the images in the regions A1 to A3 and the color of the images between the regions B1 to B3. However, if the vertical stripe chart 70 is printed as a ghost image, a density difference appears between the color of the images in the regions A1 to A3 and the color of the images between the regions B1 to B3, resulting in a defected image 71, as illustrated in FIG. 2.

The 50 percent particle diameter (D50) of the carrier for forming electrophotographic images of the present disclosure is 40 to 60 μm, and more preferably 45 to 55 μm. If the 50 percent particle diameter (D50) of the carrier is smaller than 40 μm, carrier adhesion is more likely to occur. Conversely, if the 50 percent particle diameter (D50) is larger than 60 μm, issues such as deterioration of granularity and a decrease in electric resistance over time are more likely to occur. If carrier adhesion occurs, it can cause damage to the latent electrostatic image bearer and the fixing device, such as a fixing roller, which may lead to a decline in the image quality.

In the present disclosure, it is preferable that the content of particles with a diameter of less than 22 μm in the carrier be less than 0.10 percent by number, and more preferably within the range of 0.02 to 0.09 percent by number. If the content of particles with a diameter of less than 22 μm is at least 0.10 percent by number, carrier adhesion is likely to occur.

In the present disclosure, it is preferable that the content of particles with a diameter of less than 24 μm in the carrier is 0.10 to 5.00 percent by number, and more preferably within the range of 0.10 to 2.00 percent by number. If the content of particles with a diameter of less than 24 μm is less than 0.10 percent by number, wear of the coating film progresses, leading to a decrease in electric resistance. On the other hand, if it exceeds 5.00 percent by number, carrier adhesion is likely to occur.

The 50 percent particle diameter (D50), the percent by number of particles with a diameter of less than 22 μm, and the percent by number of particles with a diameter of less than 24 μm can be measured using, for example, an MT3000EX II (available from MicrotracBEL Corp.).

### Core Particle

The core particle is not particularly limited as long as it is a magnetic substance. It includes, but is not limited to, strongly magnetized materials such as iron and cobalt, iron oxides such as magnetite, hematite, and ferrite, metal compounds and alloys, and resin particles dispersed in these magnetic substances. Of these, in terms of the environmental concerns, Mn-based ferrite, Mn—Mg-based ferrite, and Mn—Mg—Sr ferrite are preferable.

In the present disclosure, the core material is not particularly limited as long as it is a magnetic substance. It includes, but is not limited to, strongly magnetized materials such as iron and cobalt, iron oxides such as magnetite, hematite, and ferrite, metal compounds and alloys, and resin particles dispersed in these magnetic substances. Of these, in terms of the environmental concerns, Mn-based ferrite, Mn—Mg-based ferrite, and Mn—Mg—Sr ferrite are preferable.

### Coating Film

The coating film is preferably a resin, a conductive fine particle, fine particles such as inorganic fine particles, or contains these. It may furthermore optionally contain other components.

### Resin

The resin contained in the coating film include, but are not limited to, silicone resin, acrylic resin, or their combination. Silicone resin is preferable.

The silicone resin in the present disclosure represents all of the known silicone resins. Examples include, but are not limited to, straight silicone resins formed of organosiloxane bonding alone and silicone resins modified with a functional group such as alkyd, polyester, epoxy, acrylic, and urethane.

The silicone resins are commercially available. Specific examples of the straight silicone resin include, but are not limited to, KR271, KR255, and KR152, available from Shin-Etsu Chemical Co., Ltd.; and SR2400, SR2406, and SR2410, available from DOW CORNING TORAY CO., LTD.

In this case, it is possible to use simple silicone resin, but it is also possible to use other components for cross-linking reactions or charge control components simultaneously.

Specific examples of the procurable modified silicone resins include, but are not limited to, KR206 (alkyd-modified), KR5208 (acrylic-modified), ES1001N (epoxy-modified), and KR305 (urethane-modified), all available from Shin-Etsu Chemical Co., Ltd. and SR2115 (epoxy-modified) and SR2110 (alkyd-modified), both available from DOW CORNING TORAY CO., LTD.

### Conductive Fine Particle

The coating film may contain conductive fine particles for the purpose of adjusting the resistance of the carrier. From the perspective of durability, it is preferable that the conductive fine particles be inorganic pigments coated with a conductive material. Examples of conductive materials include, but are not limited to, indium-doped tin oxide, tungsten-doped tin oxide, lithium-doped tin oxide, niobium, tantalum, antimony pentoxide-doped tin oxide, and fluorine-doped variants. Considering resistance adjustment capability, manufacturing properties, and other factors, tungsten-doped tin oxide and antimony pentoxide-doped tin oxide are preferred.

As the inorganic pigments used as mother particles for the conductive fine particles, commercially available titanium dioxide, aluminum oxide, silicon dioxide, zinc oxide, barium sulfate, zirconium oxide, alkali metal titanate salts, or muscovite can all be used.

There are no particular restrictions on the surface treatment method, and an appropriate method can be selected depending on a particular application. For example, in the case of antimony, surface treatment can be performed by simultaneously adding a hydrochloric acid solution of antimony trichloride and a sodium hydroxide solution into a suspension of mother powder containing dispersed alumina, adjusting the pH, then washing and filtering through decantation, followed by drying, firing, and pulverization.

The preferred amount of conductive fine particles added to the resin is 30 to 50 parts by mass per 100 parts by mass of resin, and more preferably 35 to 45 parts by mass per 100 parts by mass of resin.

### Inorganic Fine Particle

Examples of the inorganic fine particles that may be contained in the coating film include, but are not limited to, titanium oxide, tin oxide, zinc oxide, alumina, barium sulfate, magnesium oxide, magnesium hydroxide, and hydrotalcite. These can be used alone or in combination. Among them, barium sulfate is preferred for its ability to maintain charge stability over long periods.

### Other Optional Components

The other optional components that may be contained in the coating film are not particularly limited and can be suitably selected to suit to a particular application. They include, but are not limited to, silane coupling agents and catalysts.

### Silane Coupling Agent

The silane coupling agent is not particularly limited and can be suitably selected to suit to a particular application.

Specific examples include, but are not limited to, aminosilane, methyltrimethoxysilane, methyltriethoxysilane, vinyltriacetoxysilane, γ-chloropropyltrimethoxysilane, hexamethyldisilazane, γ-aminopropyltrimethoxysilane, vinyltrimethoxysilane, octadecyldimethyl[3-(trimethoxysilyl)propyl]ammonium chloride, γ-chloropropylmethyldimethoxysilane, methyltrichlorosilane, dimethyldichlorosilane, trimethylchlorosilane, allyltriethoxysilane, 3-aminopropylmethyldiethoxysilane, 3-aminopropyltrimethoxysilane, aminoethylaminopropyltrimethoxysilane, dimethyldiethoxysilane, 1,3-divinyltetramethyldisilazane, and methacryloxyethyl dimethyl (3-trimethoxysilylpropyl) ammonium chloride. These can be used alone or in combination.

Such silane coupling agents can be procured. Specific examples of the procurable products include, but are not limited to, AY43-059, SR6020, SZ-6023, SH6026, SZ6032, SZ6050, AY43-310M, SZ6030, SH6040, AY43-026, AY43-031, sh6062, Z-6911, sz6300, sz6075, sz6079, sz6083, sz6070, sz6072, Z-6721, AY43-004, Z-6187, AY43-021, AY43-043, AY43-040, AY43-047, Z-6265, AY43-204M, AY43-048, Z-6403, AY43-206M, AY43-206E, Z6341, AY43-210MC, AY43-083, AY43-101, AY43-013, AY43-158E, Z-6920, and Z-6940 (all available from Dow Corning Toray Co., Ltd.).

The proportion of the silane coupling agent to the resin is preferably from 0.1 to 10 percent by mass. If the content of the silane coupling agent is less than 0.1 percent by mass to the resin, the attachment of core particles and fine particles with a silicone resin deteriorates so that the coating layer may be detached over an extended period of use. If the content of the silane coupling agent is greater than 10 percent by mass, filming of toner tends to occur during an extended period of use.

### Catalyst

As the catalyst, for example, a titanium-based catalyst, tin-based catalyst, zirconium-based catalyst, and aluminum-based catalyst can be used. Of these, titanium-based catalysts are preferable.

### Method of Manufacturing Carrier for Forming Electrophotographic Images

One way of forming the carrier of the present disclosure is to dissolve the resin described above in a solvent to prepare a solution for forming the coating film and apply the solution to the surface of the core particle by a known application method, followed by drying and baking of the coating film.

Specific examples of the known application methods include, but are not limited to, a dip coating method, a spray coating method, and a brushing method.

There is no specific limitation to the solvent used in the solution and it can be suitably selected to suit to a particular application.

Specific examples include, but are not limited to, toluene, xylene, methylethylketone, methylisobutyll ketone, cellosolve, and butylacetate.

The method of baking is not particularly limited and can be suitably selected to suit a particular application. It can be external or internal heating.

The device for baking is not particularly limited and can be suitably selected to suit a particular application. It includes, but is not limited to, a fixed electric furnace, fluid type electric furnace, rotary electric furnace, burner furnace, and a device with a microwave.

The average thickness of the coating layer is preferably from 0.50 to 1.10 μm and more preferably from 0.60 to 1.00 μm.

The average thickness of the coating film can be calculated, for example, through image measurement from cross-sectional SEM images of the carrier particles. Since individual variations are present among the carrier particles, and the thickness of the coating film varies depending on the location, the thickness of the coating film is measured for at least 50 carrier particles.

Furthermore, rather than measuring only one point per particle, measurements are taken at a statistically sufficient number (n) to ensure reliability. The thickness of the coating layer can be determined by measuring the thickness of the resin portion and calculating its average value. It should be noted that the thickness of the coating film does not include the resin portions covering the conductive fine particles and inorganic fine particles.

### Properties of Carrier for Forming Electrophotographic Images

The carrier of the present disclosure preferably has a volume resistivity of 10 (Log Ω·cm) to 14 (Log Ω·cm), more preferably 12 (Log Ω·cm) to 14 (Log Ω·cm), and even more preferably 13 (Log Ω·cm) to 14 (Log Ω·cm). If the volume resistivity is at least 10 (Log Ω·cm), carrier adhesion in non-image areas is less likely to occur. On the other hand, if it is at most 14 (Log Ω·cm), the edge effect is more likely to remain within an acceptable range.

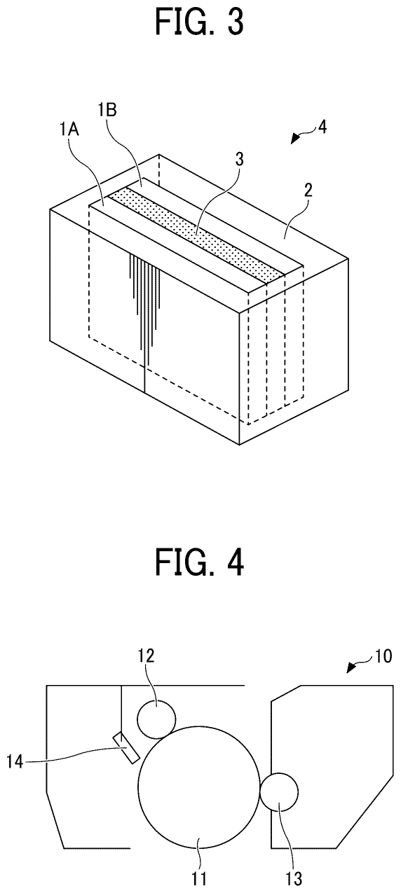

FIG. 3 is a diagram illustrating an example of a method of measuring the volume resistivity of the carrier according to an embodiment of the present disclosure. The volume resistivity of the carrier can be measured using the cell illustrated in FIG. 3. Specifically, for example, first, a cell including a fluororesin container 2 containing an electrode 1A and an electrode 1B, each of which has a surface area of 2.5 cm×4 cm and is spaced 0.2 cm apart, is filled with a carrier 3. Then the cell is subjected to tapping 10 times at a fall height of 1 cm and a tapping speed of 30 times per minute. Next, a DC voltage of 1,000 V is applied between the electrode 1A and the electrode 1B, and after 30 seconds, the resistance value r (Ω) is measured using a High Resistance Meter 4329A (available from Yokogawa Hewlett-Packard Co.).

From the measured resistance value, the volume resistivity [Ω·cm] can be calculated using the following formula.

$$r \times ( 2.5 \times 4 ) / 0.2$$

The volume resistivity (Log Ω·cm) of the carrier is the common logarithm of the volume resistivity [Ω·cm] obtained by the above measurement.

### Two-Component Developing Agent

The two-component developing agent of the present disclosure contains the carrier and toner of the present disclosure.

The mixing ratio of the toner to the carrier in the two-component developing agent is preferably 2.0 to 12.0 parts by mass of the toner to 100 parts by mass of the carrier, and more preferably 2.5 to 10.0 parts by mass.

In the two-component developing agent of the present disclosure, if the toner content is 2.0 parts by mass per 100 parts by mass of the carrier, an appropriate image density can be maintained. If the toner content is at most 12.0 parts by mass, contamination due to toner scattering in an image forming apparatus can be prevented.

### Toner

The toner contains a resin and a colorant, and preferably includes a release agent, a charge control agent, and external additives. The toner may be either a monochrome toner or a color toner. The toner may contain a release agent in order to be applied to an oil free system, in which oil preventive for toner fixation is not applied to a fixing roller. With the carrier of the present disclosure, even if the toner contains a release agent, filming can be reduced. Therefore, with the two-component developing agent of the present disclosure, good print quality can be maintained over a long period.

Furthermore, in color toners, particularly yellow toner, there is a common issue of color contamination caused by the abrasion of the carrier's coating film. However, with the two-component developing agent of the present disclosure, the occurrence of color contamination can be reduced.

Toner can be manufactured by a known method such as pulverization and polymerization. For example, when toner is manufactured by pulverization, the mixture obtained by mixing and kneading toner materials is cooled down, pulverized, and classified to manufacture mother toner particles. Next, to enhance transferability and durability, external additives are added to the mother toner particle to manufacture toner.

The device for mixing and kneading toner materials is not particularly limited and can be suitably selected to suit to a particular application. For example, batch-type twin rolls including Bumbury's mixer, continuation-type twin shaft extruder such as a KTK type twin-shaft extruder (available from KOBE STEEL, LTD.), a TEM type twin-shaft extruder (available from TOSHIBA MACHINE CO., LTD.), a twin-shaft extruder (available from ASADA IRON WORKS CO., LTD.), a PCM type twin-shaft extruder (available from IKEGAI LTD.), and a KEX type twin-shaft extruder (available from KURIMOTO LTD.); and a continuation-type single-shaft kneader such as a Co-Kneader available from COPERION BUSS AG can be preferably used as the device for mixing and kneading the toner materials.

To pulverize the melt-kneaded matter obtained by cooling the melt-kneaded toner material, it can first be coarsely pulverized using a hammer mill, a RotoPlex, or similar equipment, and then finely pulverized using a jet air mill or a mechanical fine pulverizer. It is preferable that the melt-kneaded matter of the toner material be pulverized so that the volume average particle diameter is between 3 μm and 15 μm.

Moreover, an air classifier can be used to further classify the pulverized melt-kneaded mixture. It is preferable to classify the mother toner particle to achieve a volume average particle diameter between 5 μm and 20 μm.

To add external additives to the mother toner particles, it is preferable to use a mixer to mix and stir the components, thereby deagglomerating the external additives while allowing them to adhere to the surface of the mother toner particles.

### Resin

The resin for use in the toner is not particularly limited and can be suitably selected to suit a particular application.

Specific examples include, but are not limited to, styrene polymers and substituted styrene polymers such as polystyrene, poly-p-styrene, and polyvinyltoluene; styrene copolymers such as styrene-p-chlorostyrene copolymers, styrene-propylene copolymers, styrene-vinyltoluene copolymers, styrene-methyl acrylate copolymers, styrene-ethyl acrylate copolymers, styrene-methacrylate copolymers, styrene-methyl methacrylate copolymers, styrene-ethyl methacrylate copolymers, styrene-butyl methacrylate copolymers, styrene-α-methyl chloromethacrylate copolymers, styrene-acrylonitrile copolymers, styrene-vinyl methyl ether copolymers, styrene-vinyl methyl ketone copolymers, styrene-butadiene copolymers, styrene-isopropylene copolymers, and styrene-maleic acid ester copolymers; and other resins such as polymethyl methacrylate, polybutyl methacrylate, polyvinyl chloride, polyvinyl acetate, polyethylene, polyesters, epoxy resins, polyurethane resins, polyvinyl butyral resins, polyacrylic resins, rosin, modified rosins, terpene resins, phenol resins, aliphatic or aromatic hydrocarbon resins, and aromatic petroleum resins. These can be used alone or in combination.

The resin for toner pressure fixing for use in the toner is not particularly limited and can be suitably selected to suit to a particular application.

Specific examples include, but are not limited to, polyolefins such as low molecular weight polyethylenes and low molecular weight polypropylenes; olefin copolymers such as ethylene acrylic acid copolymers, styrene-methacrylic acid copolymers, ethylene methacryrate copolymers, ethylene-vinyl chloride copolymers, ethylene-vinyl acetate copolymers, and ionomer resins; epoxy resins, polyester resins, styrene-butadiene copolymers, polyvinyl pyrrolidone, methylvinyl ether-maleic anhydride, maleic acid modified phenol resins, and phenol modified terpene resins. These can be used alone or in combination. These can be used alone or in combination.

### Colorant

The colorant (pigment or dye) for use in the toner is not particularly limited and can be suitably selected to suit to a particular application.

Specific examples include, but are not limited to, yellow pigments such as cadmium yellow, mineral fast Yellow, nickel titanium yellow, naples yellow, Naphthol Yellow S, Hanza Yellow G, Hanza Yellow 10G, Benzidine Yellow GR, quinoline yellow lake, Permanent Yellow NCG, and tartrazine lake, orange pigments such as molybdenum orange, Permanent Orange GTR, pyrazolone orange, Vulcan Orange, and Indanthrene Brilliant orange GK, red pigments such as red iron oxide, cadmium red, Permanent Red 4R, lithol red, pyrazolone red, watching red calcium salt, Lake Red D, Brilliant Carmine 6B, Eosine Lake, Rhodamine Lake B, Alizarine Lake, and Brilliant Carmine 3B, violet pigments such as Fast Violet B and Methyl Violet Lake, blue pigments such as cobalt blue, Alkali Blue, Victoria Blue Lake, Phthalocyanine Blue, metal-free Phthalocyanine Blue, Phthalocyanine Blue portion chlorinated article, Fast Sky Blue, and Indanthrene Blue BC, green pigments such as Chrome Green, chromium oxide, Pigment Green B, and Malachite Green Lake, black pigments such as adine-based pigments such as carbon black, oil furnace black, channel black, lamp black, acetylene black, and aniline black, meal salt azo pigments, metal oxides, and complex metal oxides. These can be used alone or in combination.

### Release Agent

There are no particular restrictions on the release agent used in the toner, and it can be appropriately selected according to the purpose.

Examples include, but are not limited to, polyolefins such as polyethylene and polypropylene, metal salts of fatty acids, fatty acid esters, paraffin wax, amide-based waxes, polyhydric alcohol waxes, silicone varnish, carnauba wax, and ester wax. These can be used alone or in combination.

### Charge Control Agent

The charge control agent is not particularly limited and it can be suitably selected to suit a particular application.

Specific examples include, but are not limited to, nigrosine; azine dyes with alkyl groups having 2 to 16 carbon atoms; and basic dyes such as C.I.Basic Yellow 2 (C.I.41000), C.I.Basic Yellow 3, C.I.Basic Red 1 (C.I.45160), C.I.Basic Red 9 (C.I.42500), C.I.Basic Violet 1 (C.I.42535), C.I.Basic Violet 10 (C.I.45170), C.I.Basic Violet 14 (C.I.42510), C.I.Basic Blue 1 (C.I.42025), C.I.Basic Blue 3 (C.I.51005), C.I.Basic Violet 10 (C.I.42555), C.I.Basic Violet 14 (C.I.42510), C.I.Basic Blue 1 (C.I.42025), C.I.Basic Blue 3 (C.I.51005), C.I.Basic Blue 5 (C.I.42140), C.I.Basic Blue 7 (C.I.42595), C.I.Basic Blue 9 (C.I.52015), C.I.Basic Blue 24 (C.I.52030), C.I.Basic Blue 25 (C.I.52025), C.I.Basic Blue 26 (C.I.44045), C.I.Basic Green 1 (C.I.42040), and C.I.Basic Green 4 (C.I.42000); lake pigments of these basic dyes; quaternary ammonium salts such as C.I.Solvent Black 8 (C.I.26150), benzoylmethylhexadecylammonium chloride, and decyltrimethylchloride; dialkyltin compounds such as dibutyl and dioctyl; dialkyltin borate compounds; guanidine derivatives; polyamine resins such as vinyl polymers with amino groups and condensation polymers with amino groups; metal complex of monoazo dye; salicylic acid; metal complexes of dialkylsalicylic acid, naphthoic acid, and dicarboxylic acid with Zn, Al, Co, Cr or Fe; sulfonated copper phthalocyanine pigments; organic boron salts; fluorine-containing quaternary ammonium salts; and calixarene compounds.

These can be used alone or in combination. Metal salts of white salicylic derivatives are preferable for color toner excluding black toner.

### External Additive

There are no particular restrictions on the external additives used in the toner, and they can be appropriately selected according to a particular application.

Specific examples include, but are not limited to, inorganic particles such as silica, titanium oxide, alumina, strontium titanate, silicon carbide, silicon nitride, and boron nitride; and resin particles such as polymethyl methacrylate particles and polystyrene particles with an average particle diameter of 0.05 μm to 1 μm obtained by soap-free emulsion polymerization. These can be used alone or in combination.

Of these, silica, alumina, and strontium titanate are preferable. Moreover, surface treated external additives are preferable.

Furthermore, if silica is used as an external additive for the toner, it is preferable to use a combination of two or more types of silica with different particle diameters. Specifically, it is preferable to use a combination of large-particle silica with a secondary particle diameter of at least 100 nm and small-particle silica with a secondary particle diameter of less than 100 nm. The large-particle silica with a secondary particle diameter of at least 100 nm acts as a spacer relative to the mother toner particles, allowing the separation of highly adhesive mother toner particles. By externally adding small-particle silica with a secondary particle diameter of less than 100 nm to the mother toner, fluidity can be imparted to the toner. As a result, a highly flowable toner with well-separated individual particles can be obtained, contributing to high image quality.

The secondary particle diameter of silica and similar materials can be measured using instruments such as the Zetasizer Pro (available from Spectris Co., Ltd.).

The total parts by mass of large-particle silica and small-particle silica is preferably 1.5 to 5 parts by mass per 100 parts by mass of the mother toner, and more preferably 2 to 3 parts by mass. If the total parts by mass of large-particle and small-particle silica is at least 1.5 parts by mass per 100 parts by mass of the mother toner, the fluidity of the toner does not decrease, and toner transfer defects are less likely to occur during the transfer process.

If it is at most 5 parts by mass, silica is less likely to adhere to the latent electrostatic image bearer, reducing the occurrence of defected images.

There is no specific limit to the color of the colorant for use in the toner of the present disclosure. One or more can be selected from black toner, cyan toner, magenta toner, and yellow toner and various kinds of colors can be suitably obtained by selecting the colorant. Color toner is preferable.

### Process Cartridge

The process cartridge of the present disclosure includes a latent electrostatic image bearer, a developing device to develop a latent electrostatic image formed on the surface of the latent electrostatic image bearer with the two-component developing agent to form a toner image, and at least one of a charger to charge the surface of the latent electrostatic image bearer to form the latent electrostatic image and a cleaning device to clean the latent electrostatic image bearer.

The process cartridge described above is detachably attachable to various kinds of electrophotographic image forming apparatuses and preferably detachably attachable to the image forming apparatus of the present disclosure described later.

FIG. 4 is a diagram illustrating a schematic diagram illustrating an example of the process cartridge according to an embodiment of the present disclosure. A process cartridge 10 in FIG. 4 integrally includes a latent electrostatic image bearer 11, a charger 12 to charge the latent electrostatic image bearer 11, a developing device 13 to develop a latent electrostatic image formed on the latent electrostatic image bearer 11 with the two-component developing agent of the present disclosure to form a toner image, and a cleaning device 14 to remove the toner remaining on the latent electrostatic image bearer 11 after the toner image is transferred to a printing medium. The process cartridge 10 is detachablly attached to an image forming apparatus such as a photocopier and printer.

The method of forming images using an image forming apparatus carrying the process cartridge 10 is described below.

The charger 12 uniformly charges the peripheral surface of the latent electrostatic image bearer 11, which is being rotationally driven at a predetermined peripheral speed, to a predetermined positive or negative potential. Next, an irradiator that employs slit irradiation or scanning with laser beams irradiates the peripheral surface of the latent electrostatic image bearer 11 with light to sequentially form latent electrostatic images. The developing device 13 develops the latent electrostatic image formed on the peripheral surface of the latent electrostatic image bearer 11 with the two-component developing agent of the present disclosure to form a toner image. The toner image formed on the peripheral surface of the latent electrostatic image bearer 11 is rotated in synchronization with the rotation of the latent electrostatic image bearer 11 and sequentially transferred to a transfer medium transferred from a sheet feeder to between the latent electrostatic image bearer 11 and a transfer device. Then the transfer medium on which the toner image is transferred is separated from the peripheral surface of the latent electrostatic image bearer 11 and introduced into a fixing device. After the fixing device fixes the toner image on the transfer medium, the transfer medium is ejected outside the image forming apparatus as a photocopy. After the toner image is transferred, the surface of the latent electrostatic image bearer 11 is cleaned of the toner remaining thereon with the cleaning device 14 and discharged (quenched) with a discharging device (or quencher) to be ready for next image forming.

### Image Forming Device and Image Forming Method

The image forming apparatus of the present disclosure includes a latent electrostatic image bearer, a charger to charge the latent electrostatic image bearer, an irradiator to irradiate the latent electrostatic image bearer with light to form a latent electrostatic image, a developing device to develop the latent electrostatic image formed on the latent electrostatic image bearer with the two-component developing agent of the present disclosure to form a toner image, a transfer device to transfer the toner image formed on the latent electrostatic image bearer onto a recording medium, and a fixing device to fix the toner image transferred to the recording medium. It may furthermore optionally include other devices.

The image forming method of the present disclosure preferably includes forming a latent electrostatic image on a latent electrostatic image bearer, developing the latent electrostatic image formed on the latent electrostatic image bearer with the two-component developing agent toner of the present disclosure to form a toner image, transferring the toner image formed on the latent electrostatic image bearer to the surface of a recording medium, and fixing the toner image transferred to the surface of the recording medium. It may furthermore include charging process and other optional processes.

### Latent Electrostatic Image Bearer

The size and structure of the latent electrostatic image bearer is not particularly limited, and it can be suitably selected among the devices known in the art to suit to a particular application. The shape of the latent electrostatic image bearer is not particularly limited and can be suitably selected to suit to a particular application. For example, it can take a drum-like shape and a belt-like shape. There is not specific limitation on the materials of the latent electrostatic image bearer, and it can be suitably selected to suit to a particular application.

Specific examples include, but are not limited to, inorganic compounds such as amorphous silicon and selenium for an inorganic photoconductor and organic compounds such as polysilane and phthalopolymethine for an organic photoconductor (OPC).

An example of the latent electrostatic image bearer using the organic photoconductor mentioned above is a latent electrostatic image bearer using a layered photoconductor including multiple layers—a charge-generation layer formed of non-metallic materials like phthalocyanines or titanyl phthalocyanines dispersed in a binder resin and a charge-transport layer formed of charge transport materials dispersed in a binder resin—stacked on a substrate such as an aluminum drum.

Another type is a latent electrostatic image bearer using a single-layered photoconductor with a single-layer structure on a substrate, featuring a photosensitive layer formed of both charge-generation and charge-transport materials dispersed in a binder resin. In the latent electrostatic image bearer using a single-layered photoconductor, hole transport agents and electron transport agents can be added to the photosensitive layer as charge transport materials.

Additionally, an undercoat layer may be provided between the substrate and either the charge generation layer of a multi-layered photoconductor or the photosensitive layer of a single-layered photoconductor.

### Charging Process and Charging Device

The charging process is accomplished, for instance, by applying a bias to the surface of the latent electrostatic image bearer image bearer using the charging device (charger) mentioned above.

The charging device (charger) is not particularly limited and can be suitably selected to suit to a particular application.

Specific examples include, but are not limited to, a known contact type charger that includes an electroconductive or semiconductive roller, brush, film, or a rubber blade, and a non-contact type charger using corona discharging such as corotron and scorotron.

The charger may employ any form other than a roller, for example, a magnetic brush, and a fur brush and can be selected to the specification or form of an image forming apparatus. If a magnetic brush is used, the magnetic brush is formed of a charging member made of, for example, ferrite particles such as Zn—Cu ferrite, a non-magnetic electroconductive sleeve to support the charging member, and a magnet roll disposed inside the electroconductive sleeve. In addition, in the case of a brush, material such as carbon, copper sulfate, fur electroconductively treated by metal or metal oxide, is used. The brush is formed by winding or attaching such material to metal or electroconductively treated metal core.

The charger is not limited to the contact type charger described above, but using such a contact type charger is preferable because an image forming apparatus using such a charger produces a less amount of ozone.

### Latent Electrostatic Image Forming Process and Latent Electrostatic Image Forming Device

The latent electrostatic image forming process can be carried out, for example, by exposing the surface of the latent electrostatic image bearer in an image pattern using the latent electrostatic image bearer to form a latent electrostatic image.

The latent electrostatic image forming device (irradiator) is not particularly limited and it can be suitably selected to suit to a particular application as long as it can irradiate imagewise the surface of the latent electrostatic image bearer charged by the charger.

Specific examples of such irradiators include, but are not limited to, a photocopying optical system, a rod lens array system, a laser optical system, and a liquid crystal shutter optical system.

In the present disclosure, a dorsal irradiation system can be employed, where the latent electrostatic image bearer is irradiated from the rear side in an imagewise manner.

### Developing Process and Developing Device

The developing process can be carried out, for example, by using the developing device to develop the latent electrostatic image formed on the latent electrostatic image bearer with the two-component developing agent of the present disclosure, thereby forming a toner image.

The developing device is to develop a latent electrostatic image formed on the latent electrostatic image bearer with the two-component developing agent to form a toner image.

The toner image can be formed by, for example, developing the latent electrostatic image with the two-component developing agent.

Any known developing device that can conduct development with the two-component developing agent is suitably selected without restrictions. For example, a developing device that has a developing unit which accommodates the two-component developing agent of the present disclosure and provides it to the latent electrostatic image in a contact or non-contact manner is preferable and the developing unit that accommodates the two-component developing agent container is more preferable.

The developing device employs a dry or wet developing system, and a monochrome developing unit or a full color developing unit. For example, a developing unit including a stirrer that abrasively stirs the two-component developing agent and a rotatable magnet roller as the developing agent image bearer is suitable.

In the developing unit, for example, the toner and the carrier of the present disclosure are mixed and stirred to triboelectrically charge the toner due to the friction therebetween. The toner is held on the surface of the rotating magnet roller, forming a magnet brush like a filament. Since the magnet roller is provided near the latent electrostatic image bearer, some of the toner forming the magnet brush on the magnet roller's surface is electrically attracted to the surface of the latent electrostatic image bearer. As a result, the latent electrostatic image is developed with the toner and rendered visible as a toner image of the toner on the surface of the latent electrostatic image bearer.

### Transfer Process and Transfer Device

The transfer process can be carried out, for example, by using the transfer device to transfer the toner image formed on the latent electrostatic image bearer onto a recording medium.

The transfer device is not particularly limited and it can be suitably selected according to a particular application as long as it can transfer a toner image to a recording medium. It is preferable to use an intermediate transfer body, where a toner image is primarily transferred onto the intermediate transfer body first and then secondarily transferred onto a recording medium. It is also preferable to use a two-color or more toner, preferably a full-color toner, and to include a primary transfer device for transferring the toner image onto the intermediate transfer body to form a composite transfer image, as well as a secondary transfer device for transferring the composite transfer image onto the recording medium.

The intermediate transfer body may also include an elastic intermediate transfer belt. The elastic intermediate transfer belt can have a structure in which a flexible elastic layer is laminated on a relatively rigid base layer with sufficient bendability.

Additionally, to prevent the intermediate transfer body from meandering, a guide member may be provided on its inner peripheral surface.

The transferring is conducted by, for example, charging the latent electrostatic image bearer with a transfer charger of the transfer device. The transfer device preferably includes a primary transfer device for transferring toner images to an intermediate transfer body to form a composite transfer image and a secondary transfer device for transferring the composite transfer image to a recording medium.

The intermediate transfer body is not particularly limited and can be suitably selected from the known transfer members including a transfer belt.

The transfer device (the primary transfer device and the secondary transfer device) preferably has a transfer unit that peels off and charges the toner image formed on the latent image bearer onto the side of the recording medium. One or more transfer devices can be provided. Specific examples of the transfer device include, but are not limited to, a corona transfer device using corona discharging, a transfer belt, a transfer roller, a pressure transfer roller and an adhesive transfer device.

The recording medium is typically plain paper but any paper to which a non-fixed image after development is transferred can be suitably used. PET base for an overhead projector can be also used.

### Fixing Process and Fixing Device

The fixing process can be carried out, for example, by using the fixing device to fix a toner image transferred onto the recording medium.

The fixing device fixes a toner image transferred onto a recording medium and may fix the toner image using a fixing member. It may be performed each time a toner of a respective color is transferred onto the recording medium, or it may be performed simultaneously for all colors in a stacked state.

As the fixing member, there is no specific limitation to it and it can be suitably selected to suit to a particular application. Using a known heating and pressure member is preferable. As the heating and pressure member, for example, a combination of a heating roller and a pressure roller and a combination of a heating roller, a pressure roller, and an endless belt can be used.

Such a heating and pressure member preferably conducts heating at a heating temperature of from 80 to 200 degrees Celsius.

### Other Processes and Other Devices

The other optional processes are not particularly limited and can be suitably selected to suit a particular application. Examples include discharging, cleaning, recycling, and control processes.

The other optional devices are not particularly limited and can be suitably selected to suit a particular application. Examples include discharging, cleaning, recycling, and control devices.

### Discharging Process and Discharging Device

In the discharging process, for example, a discharge bias can be applied to the latent electrostatic image bearer using the discharging device.

There are no particular limitations on the discharging device, as long as it is capable of applying a discharge bias to the latent electrostatic image bearer. It can be appropriately selected according to a particular application, and one example is a discharging lamp.

### Cleaning Process and Cleaning Device

In the cleaning process, for example, the residual toner on the latent electrostatic image bearer can be removed using the cleaning device.

There is no specific limitation to the selection of the cleaning device (cleaner) and any known cleaner that can remove the toner remaining on the latent electrostatic image bearer is suitably used.

Specific examples of such cleaners include, but are not limited to, a magnetic brush cleaner, an electrostatic brush cleaner, a magnetic roller cleaner, a blade cleaner, a brush

### Recycling Process and Recycling Device

In the recycling process, for example, the toner removed in the cleaning process be recycled into the developing device using the recycling means.

The recycling device is not particularly limited and can be suitably selected among conveyors known in the art to suit to a particular application.

### Control Process and Control Device

In the control process, the behavior of each device can be controlled using, for example, a control device.

The control device (controller) is not particularly limited and can be suitably selected to suit to a particular application as long as it can control the behavior of each device. Specific examples include, but are not limited to, a sequencer and a computer.

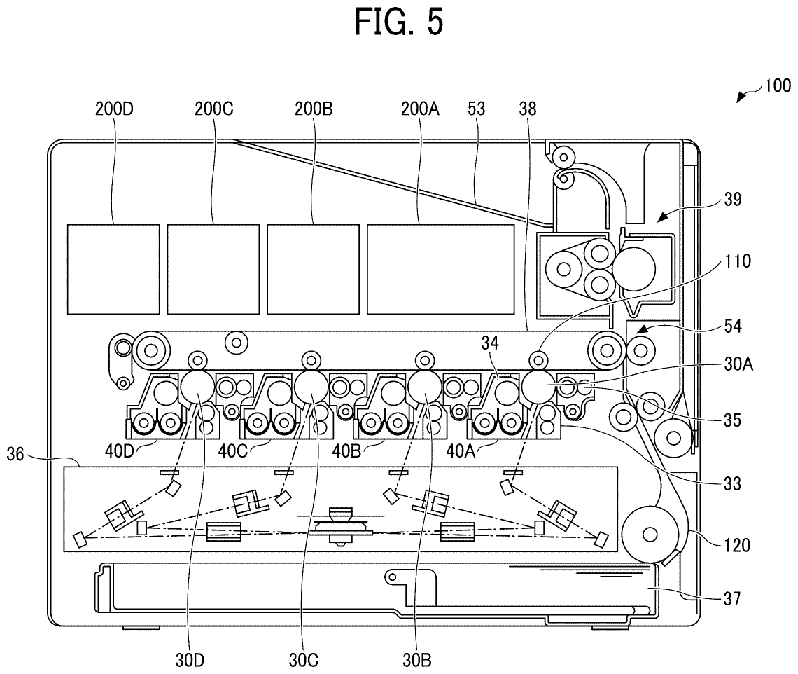

FIG. 5 is a diagram illustrating an example of an image forming apparatus according to an embodiment of the present disclosure and is a schematic diagram illustrating an example of an image forming apparatus equipped with the process cartridge of the present disclosure.

An image forming apparatus 100 is configured such that process cartridges 40A, 40B, 40C, and 40D are detachably attached to the image forming apparatus 100.

The process cartridges 40A, 40B, 40C, and 40D each include latent electrostatic image bearers 30A, 30B, 30C, and 30D.

Furthermore, each of the process cartridges 40A, 40B, 40C, and 40D are also provided with a charging device 33, a developing device 34, and a cleaning device 35.

The operation of the image forming apparatus 100 is explained as follows.

The toner image formed as described above is first transferred onto the belt-shaped intermediate transfer body 38 by the primary transfer device 110. Then the recording medium 120, which is fed from the paper feeding unit 37 and synchronized with the rotation of the latent electrostatic image bearers 30A, 30B, 30C, and 30D, is sequentially transferred with the toner image by the secondary transfer device 54 in the area between the intermediate transfer body 38 and the secondary transfer device 54.

The recording medium 120, which has received the transferred image, is separated from the surface of the intermediate transfer body 38 and guided to the fixing device 39, where the toner image is fixed. The recording medium 120 is ejected as an output (a photocopy or print) onto an external tray 53 of the apparatus.

After the toner image transfer, the surface of the latent electrostatic image bearers 30A, 30B, 30C, and 30D is cleared of residual toner remaining thereon by the cleaning device 35 to restore a clean surface. The surface is then discharged for the next image formation.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples and Comparative examples but not limited thereto.

### Manufacturing Example 1 of Core Particle

As raw materials, 21.5 kg of Fe₂O₃ (average particle diameter: 0.6 μm, SiO₂ content: 0.02 percent by mass), 10.4 kg of Mn₃O₄ (average particle diameter: 0.9 μm, SiO₂ content: 0.01 percent by mass), and 0.28 kg of SrCO₃ (average particle diameter: 0.6 μm) were dispersed in 10.0 kg of pure water. Additionally, 120 g of carbon black was added as a reducing agent, and 180 g of an ammonium polycarboxylate-based dispersant (Selna D305, available from Chukyo Yushi Co., Ltd.) was added as a dispersing agent to form a mixture.

This mixture was subjected to a wet ball milling process using a ball mill (media diameter: 2 mm) to obtain a mixed slurry.

The mixed slurry was then sprayed into hot air at approximately 130 degrees Celsius using a spray dryer, resulting in dried granules with particle diameters ranging from 10 μm to 75 μm.

These granules were placed into an electric furnace and heated up to 1,400 degrees Celsius over 4.5 hours.

Subsequently, the granules were fired by maintaining them at 1,400 degrees Celsius for 8 hours.

After firing, the material was cooled to room temperature over 10 hours.

During this process, the oxygen concentration inside the electric furnace was controlled at 5,000 ppm during firing and 1,200 ppm during cooling.

The fired product obtained was then crushed using a hammer mill (available from Sansho Industry Co., Ltd., “Hammer Crusher NH-34S,” screen opening: 0.3 mm) and classified using a vibrating sieve.

Finally, the sintered product classified underwent an oxidation treatment (high-resistance treatment) by being held at 450 degrees Celsius for 1.5 hours in an atmospheric environment, resulting in Core Particles C1.

### Manufacturing Example 1 of Conductive Fine Particle

Three hundred grams of alumina (AKP-50, available from Sumitomo Chemical Co., Ltd.), which had been fired at 900 degrees Celsius, was dispersed in pure water using a homogenizer (available from PRIMIX Corporation) to prepare a 2-liter aqueous suspension. This aqueous suspension was maintained at 70 degrees Celsius.

Separately, 160.5 g of stannic chloride (SnCl₄·5H₂O) and 4.3 g of sodium tungstate were dissolved in 750 milliliters of 2.4N hydrochloric acid to prepare an acidic solution.

One-fifth of this acidic solution and an aqueous ammonia solution were simultaneously added to the aqueous suspension over the course of one hour while maintaining the pH of the aqueous suspension at 7 to 8.

Subsequently, the remaining four-fifths of the acidic solution and a sodium hydroxide aqueous solution were added in parallel over two hours under the pH of the aqueous suspension at 7 to 8.

After the addition was complete, the pH of the aqueous suspension was adjusted to 6 using dilute hydrochloric acid, and the mixture was stirred and aged for one hour.

The aqueous suspension was washed until the conductivity of the filtrate reached 50 μS/cm or less, then filtered.

After drying at 110 degrees Celsius for 12 hours, the material was fired in an electric furnace at 700 degrees Celsius.

The powder obtained was pulverized to produce Conductive Fine Particles P1.

### Manufacturing Example 1 of Carrier for Forming Electrophotographic Image

### Preparation of Carrier for Forming Electrophotographic Image

The following Composition 1 was mixed using a homogenizer for 10 minutes to obtain a solution for forming a coating film. Using Core Particles C1 as the core particles (5,000 parts by mass), the solution obtained was applied onto the surface of Core Particles C1 to achieve a film thickness of 0.30 μm using a Spira Coater (available from Okada Seiko Co., Ltd.) at a coater temperature of 55 degrees Celsius.

After drying, the coated particles were fired in an electric furnace at 200 degrees Celsius for 1 hour.

After cooling, the fired ferrite powder bulk was crushed using a 63 μm mesh sieve, obtaining Carrier 1 for Forming Electrophotographic Image with a baked coating film.

### Composition 1

Silicone resin solution (20 percent by mass solid content, SR2410, available from Toray Dow Corning Silicone Co., Ltd.): 600 parts by mass
Titanium catalyst (60 percent by mass solid content, TC-750, available from Matsumoto Fine Chemical Co., Ltd.): 4 parts by mass
Amino silane (100 percent by mass solid content, SH6020, available from Toray Dow Corning Silicone Co., Ltd.): 3.2 parts by mass
Conductive Fine Particles P1: 36 parts by mass
Toluene: 1,000 parts by mass

### Particle Size Distribution

Using MT3000EX II (available from MicrotracBEL), the following measuring conditions were set:
Particle refractive index: 2.42
Solvent refractive index: 1.00
Distribution display: Volume-based

Carrier 1 was measured at 1 g, and the 50 percent particle diameter (D50) and the percentage by number of particles with diameters below 22 μm and 24 μm were determined. The D50 value was recorded as measured. The percentage by number of particles with diameters below 22 μm and 24 μm was recalculated from volume-based distribution to number-based distribution. Results for Carrier 1:
D50: 40 μm
Percentage by number of particles below 22 μm: 0.09 percent by number
Percentage by number of particles below 24 μm: 5.00 percent by number. The results are shown in Table 1.

### Volume Resistivity

The volume resistivity (Log Ω·cm) of Carrier 1 was measured using Cell 4 illustrated in FIG. 3. As illustrated in FIG. 3, the cell 4 that included electrodes 1A and 1B with a surface area of 2.5 cm×4 cm, and a fluororesin container 2 housing them at a distance of 0.2 cm, was filled with Carrier 1 as the carrier 3 in FIG. 3. The cell 4 was tapped 10 times at a drop height of 1 cm and a tapping speed of 30 times per minute. Subsequently, a DC voltage of 1,000 V was applied between the electrodes 1A and 1B, and the resistance value r (Ω) after 30 seconds was measured using a high-resistance meter (Model 4329A, available from Yokogawa Hewlett-Packard Co., Ltd.). The volume resistivity (Ω·cm) was then calculated using the following formula. The logarithm of the volume resistivity (Ω·cm) was determined to obtain the volume resistivity (Log ω·cm). The volume resistivity (Log Ω·cm) of Carrier 1 was 13.2 Log Ω·cm. The results are shown in Table 1.

$$r \times ( 2.5 \times 4 ) / 0.2$$

### Manufacturing Example 2 of Carrier for Forming Electrophotographic Image

Carrier 2 for forming electrophotographic images was obtained in the same manner as in Manufacturing Example 1 of Carrier for Forming Electrophotographic Image except that the sieve used for crushing the ferrite powder bulk after firing and cooling was changed to a 90 μm mesh sieve. The 50 percent particle diameter (D50), the percentage by number of particles with a diameter below 22 μm, the percentage by number of particles with a diameter below 24 μm, and the volume resistivity (Log Ω·cm) of Carrier 2 were determined using the same method as for Carrier 1. Results for Carrier 2:
D50: 50 μm
Percentage by number of particles below 22 μm: 0.04 percent by number
Percentage of particles below 24 μm: 2.00 percent by number
Volume resistivity: 13.1 Log Ω·cm. The results are shown in Table 1.

### Manufacturing Example 3 of Carrier for Forming Electrophotographic Image

Carrier 3 for forming electrophotographic images was obtained in the same manner as in Manufacturing Example 1 of Carrier for Forming Electrophotographic Image except that the sieve used for crushing the ferrite powder bulk after firing and cooling was changed to a 125 μm mesh sieve. The 50 percent particle diameter (D50), the percentage by number of particles with a diameter below 22 μm, the percentage by number of particles with a diameter below 24 μm, and the volume resistivity (Log Ω·cm) of Carrier 3 were determined using the same method as for Carrier 1. Results for Carrier 3:
D50: 60 μm
Percentage by number of particles below 22 μm: 0.02 percent by number
Percentage of particles below 24 μm: 0.10 percent by number
Volume resistivity: 13.1 Log Ω·cm. The results are shown in Table 1.

### Manufacturing Example 4 of Carrier for Forming Electrophotographic Image

In Production Example 2, Carrier 4 was obtained in the same manner, except that Carrier 4 for forming electrophotographic images was obtained in the same manner as in Manufacturing Example 2 of Carrier for Forming Electrophotographic Image except that 36 parts by mass of barium sulfate (BF-10, available from Sakai Chemical Industry Co., Ltd.) was added as an inorganic fine particle to Composition 1, forming Composition 2. The 50 percent particle diameter (D50), the percentage by number of particles with a diameter below 22 μm, the percentage by number of particles with a diameter below 24 μm, and the volume resistivity (Log Ω·cm) of Carrier 4 were determined using the same method as for Carrier 1. Results for Carrier 4:
D50: 50 μm
Percentage by number of particles below 22 μm: 0.04 percent by number
Percentage of particles below 24 μm: 2.00 percent by number
Volume resistivity: 13.3 Log Ω·cm. The results are shown in Table 1.

### Manufacturing Example 5 of Carrier for Forming Electrophotographic Image

Carrier 5 for forming electrophotographic images was obtained in the same manner as in Manufacturing Example 1 of Carrier for Forming Electrophotographic Image except that the sieve used for crushing the ferrite powder bulk after firing and cooling was changed to a 53 μm mesh sieve. The 50 percent particle diameter (D50), the percentage by number of particles with a diameter below 22 μm, the percentage by number of particles with a diameter below 24 μm, and the volume resistivity (Log Ω·cm) of Carrier 5 were determined using the same method as for Carrier 1. Results for Carrier 5:
D50: 35 μm
Percentage by number of particles below 22 μm: 0.12 percent by number
Percentage of particles below 24 μm: 5.20 percent by number
Volume resistivity: 13.2 Log Ω·cm. The results are shown in Table 1.

### Manufacturing Example 6 of Carrier for Forming Electrophotographic Image

Carrier 5 for forming electrophotographic images was obtained in the same manner as in Manufacturing Example 1 of Carrier for Forming Electrophotographic Image except that the sieve used for crushing the ferrite powder bulk after firing and cooling was changed to a 150 μm mesh sieve. The 50 percent particle diameter (D50), the percentage by number of particles with a diameter below 22 μm, the percentage by number of particles with a diameter below 24 μm, and the volume resistivity (Log Ω·cm) of Carrier 5 were determined using the same method as for Carrier 1. Results for Carrier 5:
D50: 65 μm
Percentage by number of particles below 22 μm: 0.00 percent by number
Percentage of particles below 24 μm: 0.08 percent by number
Volume resistivity: 13.5 Log Ω·cm. The results are shown in Table 1.

### Manufacturing Example 1 of Toner

### Preparation of Toner 1

### Synthesis of Polyester Resin A

In a reaction vessel equipped with a thermometer, stirrer, condenser, and nitrogen inlet tube, the following materials were added:
443 parts by mass of bisphenol A PO adduct (hydroxyl value: 320 mg KOH/g)
135 parts by mass of diethylene glycol
422 parts by mass of terephthalic acid
2.5 parts by mass of dibutyltin oxide.

The mixture was reacted at 200 degrees Celsius until the acid value reached 10 mg KOH/g, resulting in Polyester Resin A. The Polyester Resin A obtained had a glass transition temperature (Tg) of 63 degrees Celsius and a peak number-average molecular weight of 6,000.

### Synthesis Example of Polyester Resin B

In a reaction vessel equipped with a thermometer, stirrer, condenser, and nitrogen inlet tube, the following materials were added:
443 parts by mass of bisphenol A PO adduct (hydroxyl value: 320 mg KOH/g)
135 parts by mass of diethylene glycol
422 parts by mass of terephthalic acid
2.5 parts by mass of dibutyltin oxide.

The mixture was reacted at 230 degrees Celsius until the acid value reached 7 mg KOH/g, resulting in Polyester Resin B. The Polyester Resin B obtained had a glass transition temperature (Tg) of 65 degrees Celsius and a peak number-average molecular weight of 16,000.

### Manufacturing of Mother Toner Particle

The mother toner composition below was prepared by mixing the raw materials using a Henschel mixer (Model 20B, available from NIPPON COKE & ENGINEERING. CO., LTD.) at 1,500 rpm for 3 minutes.

The mixture was then kneaded using a single-screw kneader (small-scale Buss Co-Kneader, available from Buss AG) under the following conditions:
Set temperature: 100 degrees Celsius at the inlet, 50 degrees Celsius at the outlet
Feed rate: 2 kg/hr.

This process yielded mother toner.

### Mother Toner Composition

Polyester Resin A: 40 parts
Polyester Resin B: 60 parts
Carnauba wax WA-05 (available from Cerarica NODA Co., Ltd.): 1 part
Carbon black (#44, available from Mitsubishi Chemical Corporation): 15 parts

Next, the mother toner was kneaded, rolled, and cooled, then pulverized using a pulverizer. Furthermore, fine pulverization was performed using an I-type mill (Model IDS-2, available from Nippon Pneumatic MFG Co., Ltd.) with a flat-type impact plate under the conditions of an air pressure of 6.8 atm/cm² and a feed rate of 0.5 kg/hr. The material was then classified using a classifier (Model 132MP, available from Alpine) to obtain mother toner particles.

Treatment with External Additive

To 100 parts by mass of the mother toner particles, the following external additives were added:
0.5 parts by mass of large-particle silica (MSP-009, available from Tayca Corporation, secondary particle diameter: 160 nm)
1.0 part by mass of small-particle silica (MSP-015, available from Tayca Corporation, secondary particle diameter: 40 nm)

The mixture was mixed using a Henschel mixer, yielding Toner 1. The volume average particle diameter of Toner 1 was 7.2 μm.

### Manufacturing Examples 1 to 6 of Two Component Developing Agents

### Manufacturing of Developing Agents 1 to 6

To 93 parts by mass of each of Carriers 1 to 6 for Forming Electrophotographic Image obtained in Manufacturing Examples 1 to 6 of Carrier for Forming Electrophotographic Image, 7.0 parts by mass of Toner 1 obtained in Manufacturing Example 1 of Toner was added. The mixture was stirred using a ball mill for 20 minutes, yielding Two-component Developing Agents 1 to 6. Two-component Developing Agents 1 to 4 were designated as Examples 1 to 4, while Two-component Developing Agents 5 and 6 were designated as Comparative Examples 1 and 2.

TABLE 1

| | Two | | Carrier No. for | 50 percent |
|---|---|---|---|---|
| | component | | forming | particle |
| | developing | Toner | electrophotographic | diameter |
| | agent No. | No. | images | (D 50) |
| Example 1 | 1 | 1 | 1 | 40 |
| Example 2 | 2 | 1 | 2 | 50 |
| Example 3 | 3 | 1 | 3 | 60 |
| Example 4 | 4 | 1 | 4 | 50 |
| Comparative | 5 | 1 | 5 | 35 |
| Example 1 | | | | |
| Comparative | 6 | 1 | 6 | 65 |
| Example 2 | | | | |

| | Particle | Particle | Inorganic | |
|---|---|---|---|---|
| | diameter | diameter | fine | |
| | below 22 | below 24 | particle | Volume |
| | μm (percent | μm (percent | in coated | resistivity |
| | by number) | by number) | film | (Ω · m) |
| Example 1 | 0.09 | 5.00 | None | 13.2 |
| Example 2 | 0.04 | 2.00 | None | 13.1 |
| Example 3 | 0.02 | 0.10 | None | 13.1 |
| Example 4 | 0.04 | 2.00 | Barium | 13.3 |
| | | | sulfate | |
| Comparative | 0.12 | 5.20 | None | 13.2 |
| Example 1 | | | | |
| Comparative | 0.00 | 0.08 | None | 13.5 |
| Example 2 | | | | |

### Properties of Two-component Developing Agent

The two-component developing agents obtained were evaluated using a digital color copier/printer (Ricoh Pro C901, available from Ricoh Co., Ltd.) under environmental conditions of 23 degrees Celsius and 55 percent relative humidity. Specifically, using Two-component Developing Agents 1 to 6 from Examples 1 to 4 and Comparative Examples 1 and 2, printing was performed on 100 sheets (initial stage) at an image coverage rate of 2 percent, followed by continuous printing up to 1 million sheets (long-term stage) to evaluate solid carrier adhesion.

### Solid Carrier Adhesion

Even if carrier adhesion occurs on the latent electrostatic image bearer, only a portion of the carrier transfers onto the paper. Therefore, the evaluation was conducted using the following method.

### Under Developing Conditions:

Charging potential (Vd): −600V
Post-exposure potential of the image section (solid area original): −100V
Developing bias: DC −500V

The number of adhered carrier particles on a solid image (30 mm×30 mm) was counted on the latent electrostatic image bearer, and the adhesion in solid areas was evaluated based on the following criteria. The evaluation results after printing 100 sheets (initial stage) and 1 million sheets (long-term stage) are shown in Table 2.

### Evaluation Criteria

A: Excellent (No carrier adhesion)
B: Good (Carrier adhesion present but does not affect the image)
C: Acceptable (Carrier adhesion present, visible in the image but at acceptable level
D: Not usable (Carrier adhesion visible in the image, at unacceptable level)

### Ghost Image

For ghost image evaluation, the vertical stripe chart, Chart 70 as illustrated in FIG. 1, was printed. In an image area 61 of the Chart 70, the color density of an image area A1, not adjacent to a non-image area 62 and the color density of an image area B1, adjacent to the non-image area 62 were measured using an X-Rite 938 (available from X-Rite Inc.) to obtain the difference between both color densities. Similarly, the color density differences between A2 and B2, as well as A3 and B3, were determined. The average value of these three color density differences was defined as average density difference ΔID, and ghost image evaluation was conducted according to the following ranking criteria. A to C were considered acceptable under the present disclosure, while D was deemed unacceptable. The evaluation results after printing 100 sheets (initial stage) and 1 million sheets (long-term stage) are shown in Table 2. In the vertical stripe chart 70 of FIG. 1, the lengths of regions A1 to A3, not adjacent to non-image area 62, and regions B1 to B3, adjacent to non-image area 6, in a paper feed direction 63 correspond to one full rotation length L of the latent electrostatic image bearer sleeve.

### Evaluation Criteria

$$A : 0.01 \geq Δ ID ( Excellent ) \\ B : 0.01 < Δ ID ≦ 0.03 ( Good ) \\ C : 0.03 < Δ ID ≦ 0.06 ( Usable ) \\ D : 0.06 < Δ ID ( Not practical for use )$$

TABLE 2

| | | | Solid | | |
|---|---|---|---|---|---|
| | Two | Solid | carrier | | Ghost |
| | component | carrier | adhesion | Ghost | image |
| | developing | adhesion | (long- | image | (long- |
| | agent No. | (initial) | term) | (initial) | term) |
| Example 1 | 1 | C | C | B | A |
| Example 2 | 2 | B | B | B | B |
| Example 3 | 3 | A | B | C | B |
| Example 4 | 4 | A | A | A | A |
| Comparative | 5 | D | D | B | A |
| Example 1 | | | | | |
| Comparative | 6 | A | D | D | B |
| Example 2 | | | | | |

In Examples 1 to 4, which used two-component developing agents 1 to 4, the evaluation results for solid carrier adhesion (initial and long-term) and ghost images (initial and long-term) were within the range of A to C.

In Comparative Example 1, which used two-component developing agents 5, the 50 percent particle diameter (D50) of Carrier 5 was less than 40 μm, with a particle content of at least 0.10 percent for particles smaller than 22 μm and more than 5.00 percent for particles smaller than 24 μm. Due to these properties, carrier adhesion was more likely to occur, and the evaluation results for solid carrier adhesion (initial and long-term) were both rated as D.

In Comparative Example 2, which used two-component developing agent 6, the 50 percent particle diameter (D50) of Carrier 5 was greater than 60 μm, and the particle content of particles smaller than 24 μm was less than 0.10 percent. As a result, contact between carriers caused wear of the coating film, leading to a decrease in electric resistance and an increased likelihood of carrier adhesion. Consequently, the evaluation result for solid carrier adhesion (long-term) was rated as D. Additionally, the evaluation result for ghost images (initial) was also D.

As seen in these results, it was demonstrated that the carrier for forming electrophotographic image satisfying the configuration of the present disclosure can effectively reduce carrier adhesion and ghost images over an extended period.

Aspects of the present disclosure are, for example, as follows.

### Aspect 1

A carrier contains a particle containing a core particle and a coating film that covers the core particle, wherein the carrier has a 50 percent particle diameter (D50) is between 40 μm and 60 μm, the content of the carrier having a particle diameter of less than 22 μm is less than 0.10 percent by number, and the content of the carrier having a particle diameter of less than 24 μm is between 0.10 percent by number and 5.00 percent by number.

### Aspect 2

The carrier according to Aspect 1 mentioned above, wherein the coating film contains an inorganic fine particle.

### Aspect 3

The carrier according to Aspect 1 or 2 mentioned above, wherein the inorganic fine particle contains barium sulfate.

### Aspect 4

A two-component developing agent contains the carrier of any one of Aspects 1 to 3 mentioned above and a toner.

### Aspect 5

A process cartridge includes a latent electrostatic image bearer, a charger to charge the surface of the latent electrostatic image bearer to form a latent electrostatic image, a developing device to develop the latent electrostatic image formed on the surface of the latent electrostatic image bearer with the two-component developing agent of Aspect 4 mentioned above to form a toner image, and a cleaning device to clean the latent electrostatic image bearer.

### Aspect 6

An image forming apparatus includes a latent electrostatic image bearer, a charger to charge the surface of the latent electrostatic image bearer to form a latent electrostatic image, an irradiator to irradiate the latent electrostatic image bearer with light to form a latent electrostatic image, a developing device to develop the latent electrostatic image formed on the surface of the latent electrostatic image bearer with the two-component developing agent of Aspect 4 mentioned above to form a toner image, a transfer device to transfer the toner image formed on the latent electrostatic image bearer onto a recording medium; and, a fixing device to fix the toner image transferred to the recording medium.

### Aspect 7

An image forming method includes forming a latent electrostatic image on a latent electrostatic image bearer, developing the latent electrostatic image formed on the latent electrostatic image bearer with the two-component developing agent of Aspect 4 mentioned above to form a toner image, transferring the toner image formed on the latent electrostatic image bearer to a recording medium, and fixing the toner image transferred to the recording medium.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A carrier comprising:
a particle comprising:
a core particle; and
a coating film that covers the core particle,
wherein the carrier has a 50 percent particle diameter (D50) is between 40 μm and 60 μm,
a content of the carrier having a particle diameter of less than 22 μm is less than 0.10 percent by number, and
a content of the carrier having a particle diameter of less than 24 μm is between 0.10 percent by number and 5.00 percent by number.

2. The carrier according to claim 1, wherein the coating film comprises an inorganic fine particle.

3. The carrier according to claim 2, wherein the inorganic fine particle comprises barium sulfate.

4. A two-component developing agent comprises:
the carrier of claim 1; and
a toner.

5. A process cartridge comprising:
a latent electrostatic image bearer;
a charger to charge a surface of the latent electrostatic image bearer to form a latent electrostatic image:
a developing device to develop the latent electrostatic image formed on the surface of the latent electrostatic image bearer with the two-component developing agent of claim 4 to form a toner image; and
a cleaning device to clean the latent electrostatic image bearer.

6. An image forming apparatus comprising:
a latent electrostatic image bearer;
a charger to charge a surface of the latent electrostatic image bearer to form a latent electrostatic image;
an irradiator to irradiate the latent electrostatic image bearer with light to form a latent electrostatic image;
a developing device to develop the latent electrostatic image formed on the surface of the latent electrostatic image bearer with the two-component developing agent of claim 4 to form a toner image;
a transfer device to transfer the toner image formed on the latent electrostatic image bearer onto a recording medium; and
a fixing device to fix the toner image transferred to the recording medium.

7. An image forming method comprising:
forming a latent electrostatic image on a latent electrostatic image bearer;
developing the latent electrostatic image formed on the latent electrostatic image bearer with the two-component developing agent of claim 4 to form a toner image;
transferring the toner image formed on the latent electrostatic image bearer to a recording medium; and
fixing the toner image transferred to the recording medium.
